(19) United States
(12) Patent Application Publication
(10) Pub. No.: US 2023/0071629 A1
(43) Pub. Date: Mar. 9, 2023

(54) METHOD OF REMOVING REMOVABLE SHEET PARTS FROM A SHEET USING A REMOVER

(71) Applicant: Airborne International B.V., 2497 GB 's-Gravenhage (NL)

(72) Inventors: Leonardus Georgius ARKESTEIJN, 2497 GB 's-Gravenhage (NL); Alexander Michiel OUWEHAND, 2497 GB 's-Gravenhage (NL); Evert Jan VRUGGINK, 2497 GB 's-Gravenhage (NL)

(21) Appl. No.: 17/795,190

(22) PCT Filed: Jan. 29, 2021
(86) PCT No.: PCT/NL2021/050059

§ 371 Date: Jul. 25, 2022

(30) Foreign Application Priority Data
Jan. 30, 2020 (NL) 2024796
Jan. 30, 2020 (NL) 2024797

(51) Int. Cl. B26D 7/18; B26D 5/00; B26D 7/01

(52) U.S. Cl. CPC B26D 7/1863; B26D 5/005; B26D 7/018

(57) ABSTRACT

Method of removing a target removable sheet part, in particular a product cutout, from a sheet using a remover, comprising the steps of:
arranging the remover and the sheet relative to each other so that the plurality of actuators corresponds in position with the sheet,
engaging the contact portions of at least one of a group of the plurality of actuators of which the position corresponds to a target removable sheet part of the sheet with the target removable sheet part, the at least one actuator being in its extended state;
reconfiguring one or more of the engaged actuators of the group from its extended state to its retracted state with the target removable sheet part remaining engaged with the contact portion of said actuator to at least partially move the target removable sheet part from the sheet towards the carrier plane of the remover;
moving the remover away from the sheet with the contact portions of said one or more the actuators of the group being engaged with the target removable sheet part, and
performing an assisting operation with at least one actuator prior to the step of moving the remover away from the sheet.

The invention generally relates to removing product cutouts from a sheet, and in particular to removing product cutouts from a flexible sheet comprising tacky material. An example of a flexible sheet comprising tacky material is a composite sheet comprising fibers held in a resinous matrix material, e.g. as used in the aerospace industry.

Products may be cut out from a sheet with a cutting device, in particular a numerically controlled cutting device, e.g. a laser cutter, a jet cutter or a knife cutter. The sheets is typically in a flat, planar orientation when the cutting device is controlled to make product cutouts in the sheet. As sheets are typically stored rolled up on a roll, the sheet material may need to be uncoiled form the roll and possibly flattened before cutting.

The product cutouts may be made in the sheet by cutting the full contour of the cutout product, e.g. an inner and outer contour. However, the contour of a product cutout may also be partially formed by an uncut boundary of the sheet. The cut for the product cutout may be made as a continuous cut, but may also be built up as an aggregate of several cuts. A first portion of the cut of the contour of a cutout product may be cut at a first cutting stage, e.g. when cutting a part of the contour of an adjacent product cutout, and a second portion of the cut of the contour of a product cutout may be cut at a second cutting stage, e.g. when cutting a remaining part of the contour of the product cutout.

Typically, the use of sheet material may be optimized by nesting product cutouts in the sheet, especially when the sheet material is relatively expensive. The portion of the sheet that remains after removal of the product cutouts from the sheet is called the skeleton. Preferably the surface area of the skeleton is minimized, as it often needs to be scrapped.

The product cutouts may be final products or unfinished products that require subsequent production steps such as kitting, layup in a mold and consolidation. For instance, layered unfinished product cutouts may be consolidated by subjecting them to heat and/or pressure to form a consolidated final or intermediate product, in particular a high strength, low weight product for use in demanding applications, e.g. structural parts for the aerospace industry. Product cutouts in a sheet may each be identical, but may also differ, e.g. having different shapes and/or sizes.

Product cutouts are typically removed manually from the sheet. Often the sheet is relatively flexible and/or tacky, which complicates proper removal. For example, during removal certain portions of a cutout product may trail behind by adhering to the sheet and/or parts of the sheet may be dragged along with the product cutout. This may be detrimental to the integrity of the removed product and/or other products in the sheet. Sheet properties, such as an extent of flexibility and/or tackiness, and/or product shape can make removal more difficult. For instance, the tackier the sheet and/or the more complex the shape of the contour of the product cutout, the more difficult removal becomes. Even with careful manual handling errors may not always be avoided.

Tight quality control may be required which increase costs and processing time. In particular, unfinished products are delicate and should be handled with care to prevent contamination and loss of integrity.

It has previously been proposed to automate removal of product cutouts from sheets with a system provided with a product remover comprising actuators for gripping a product. Although automated removal of product cutouts with such a system has certain advantages over manual removal, automated removal is still hampered by system, and in particular product remover, constraints. For instance, the occurrence of dragging and/or trailing of sheet material from the product remover may damage the product cutout being removed or remaining product cutouts in the sheet.

The invention aims to alleviate at least some of the above mentioned disadvantages. In particular, the invention aims to provide an improved method and device for removing cutout products from a sheet, especially with which product integrity can more easily be maintained.

Thereto, the invention provides for a method of removing product cutouts from a sheet, wherein a sheet part that is adjacent to a target product cutout is removed first from the sheet to improve removability of the target product cutout from the sheet in a further removal step.

By removing an adjacent sheet part first, an expectation of a proper removal of the target product cutout from the sheet in a further removal step may be improved. For instance, an expectation of a proper removal of a cutout for a given sheet, given cutout size and geometry, given product remover, and given product remover manipulation, may be determined by n removal steps, in which n is a natural number e.g. 100, 1000, 10000 or more, and ascertaining the chance of a successful removal. Successful removal may be defined within this context of only the complete cutout. That is to say, each cutout removal step that is free of inadvertent removal of excess sheet material, trailing and/or dragging material, such as a product cutout or an adjacent sheet part, from the product remover may represent a successful or proper removal. Similarly, the expectation of a proper removal may be determined for manual removal. Complex cutout shapes of a given size may e.g. have ca. 10% or less chance as expectation of a proper removal compared to simple cutout shapes of a given size having e.g. ca. 90% or more chance as expectation of a proper removal. In particular, when the expectation of a proper removal of a target product cutout is smaller than that of the adjacent sheet part and removal thereof improves the removability of the target product cutout, the adjacent sheet part is removed first.

The further removal step of the target product cutout from the sheet may be directly subsequent to removal of the adjacent sheet part, but may also be some time later, e.g. after a number, such as one, two, three, or more, of other removal steps.

In the method, the adjacent sheet part may also be a product cutout. This way, the product cutout with a higher expectation of a proper removal compared to the target product cutout is removed first. Thereby, the removability of the target product cutout may be improved.

In the method, the adjacent sheet part may be an auxiliary cutout that forms a removable part of a skeleton of the sheet that contains the product cutouts. This way, the removability of target product cutouts may be improved by first picking parts of the skeleton as auxiliary cutouts. This way, the occurrence of the auxiliary cutout as adjacent sheet part being dragged along during removal of the target product cutout may be counteracted by removing the auxiliary cutout first.

Using the method, removal of the adjacent sheet part may free at least a part of the contour of the target product cutout. This way, the target product cutout in the sheet comes to lie at least partly free from adjacent sheet parts, thereby facilitating removal of the target product cutout in a further removal step.

In the method, the target product cutout may surround the adjacent sheet part, for example an inner adjacent sheet part surrounded by the product cutout as an outer cutout. For instance, the contour of the adjacent sheet part may correspond to the inner contour of the target product cutout such that the target product cutout surrounds the adjacent sheet part in the sheet. In particular, the target product cutout may surround the adjacent sheet part in the sheet such that at the contour of the adjacent sheet part may partly be formed by the sheet boundary. This way, surrounded adjacent sheet parts may be compartmentalized from the sheet by surrounding product cutouts, thereby forming removable parts of the skeleton of the sheet as auxiliary cutouts.

Elegantly, the target product cutout may include a recessed portion that partly surrounds the adjacent sheet part, e.g. a cove, slot, niche and/or indentation.

In the method, the adjacent sheet part may partially surround a protruding part of the target product cutout.

In the method, the contour of the target product cutout may present a contour portion having a ‘complex’ geometry, such as e.g. having a relatively narrow, jagged and/or rugged shape. In particular, the contour portion of a target product cutout having a ‘complex’ geometry may be defined by a recessed portion or a protruding part that has a relatively large perimeter to surface area ratio, e.g. relative to the rest of the target product cutout.

In the method, the contour of the adjacent sheet part may comprise at least one convex segment that is adjacent to the target product cutout. This way, the adjacent sheet part is at least partly enclosed by the target product cutout.

In the method, the removal step may be performed by a remover comprising a carrier having a plurality of actuators arranged to engage target product cutouts and/or adjacent sheet parts, wherein the remover moves away from the sheet with a group of the actuators being engaged with the adjacent sheet part first such that the target product cutout can be removed in a further removal step. This way, the method may be automated such that e.g. the cost efficiency and handling time of removal can be increased. The remover may e.g. comprise electrostatic or suction grippers as actuators.

In the method, the sheet may be supported on a substantially planar pick-up plane, wherein the pick-up plane facing the sheet presents a relatively frictitious surface that is arranged to grip the sheet with product cutouts and hold it in place laterally along the pick-up plane. This way, shifts of the sheet and/or disarrangement of a layout or nest of the product cutouts in the sheet may be counteracted. In particular, this may benefit automated removal with the above mentioned remover.

When the pick-up plane moves in a transport direction during removal, the throughput may be improved. In particular, the pick-up plane supporting sheets with product cutouts may move in the transport direction along a remover during use.

In the method, the pick-up plane may comprise apertures opening upwardly towards the sheet through which suction is applied to the sheet for engaging the sheet transversely to the pick-up plane. This way, the sheet with product cutouts may be gripped, in particular in a direction substantially opposite to removal. Thereby, dragging along of parts of the sheet with the adjacent sheet part or the product cutout may be counteracted, which facilitates proper removal. The apertures may be divided into at least two subgroups over the pick-up plane that are each separately actuatable. This way, suction may be focussed in the respective subgroups, thereby concentrating the suction force as compared to actuating all apertures at once. This may allow reduction of energy consumption and/or operative costs.

In the method, removal of the adjacent sheet part may be done gradually starting from a starting point at the contour of the adjacent sheet part, wherein a removed contour of the adjacent sheet part increases incrementally. This way, the adjacent sheet part may be peeled away which may counteract damage to the target product part.

Advantageously, the starting point may be defined by an angle in the contour of the adjacent sheet part, which may allow concentration of the removal. In particular, the angle may be less than 180 degrees, such as less than 165 degrees, less than 150 degrees, less than 135 degrees or less than 90 degrees.

When the sheet comprises at least one auxiliary cutting line so that an auxiliary cutout is defined that presents a removable part of the skeleton of the sheet, proper removal of target product cutouts may be further improved.

Elegantly, the contour of the auxiliary cutout may be collectively formed by its common cutting line or lines with at least one product cutout and the at least one auxiliary cutting line.

The invention further relates to a method of nesting product cutouts in a sheet, wherein cutting lines are defined for a target product cutout and wherein for a sheet part that is adjacent to the product cutout an auxiliary cutting line is defined so that an auxiliary cutout is formed that presents a removable part of a skeleton of the sheet that can be removed from the sheet in a removal step to improve removability of the target product cutout from the sheet in a further removal step.

By defining an auxiliary cutting line so that an auxiliary cutout is formed, a part of the sheet may become removable, in particular a removable part of a skeleton of the sheet may be formed. Such a removable auxiliary cutout can be removed from the sheet in a first removal step to improve removability of the target product cutout. This way, an expectation of a proper removal of a product cutout may be improved by removing the removable auxiliary cutout first.

Using the method, at least one auxiliary cutting line may be positioned such that it closes a common cutting line between an adjacent sheet part and a product cutout that partly surrounds the adjacent sheet part to form a closed loop so as to define the removable auxiliary cutout. This way, the removable auxiliary cutout may be formed conveniently. The common cutting line may correspond with the contour portion of a product cutout that partly surrounds the adjacent sheet part, such as a recessed portion or a protruding part of the product cutout. For example, a recessed portion of the target product cutout can relatively easily become a removable auxiliary cutout by forming a loop that closes off the recessed portion.

Using the method, a first auxiliary cutting line may connect the contour of a product cutout with the contour of a neighbouring product cutout at a first position and a second auxiliary cutting line may connect the contour of the product cutout with the contour of the or another neighbouring product cutout at a second position to define a removable auxiliary cutout. This way, the removable auxiliary cutout may be formed between two or more neighbouring product cutouts by defining auxiliary cutting lines. The second auxiliary cut may start from the first auxiliary cut, but may also start at a spaced apart distance along the contour of one of the neighbouring product cutouts. If the second auxiliary cut starts from the first auxiliary cut, it has to connect the neighbouring product cutout at a different location.

Elegantly, a boundary spacing between neighbouring product cutouts may be defined in order to improve an expectation of a proper removal of each product cutout.

In the method, the auxiliary cutting lines may be based on a user input.

The invention furthermore relates to a method of removing a target removable sheet part, in particular a product cutout, from a sheet using a remover, the remover comprising a carrier having a plurality of actuators extending from a carrying plane of the carrier, the actuators each being provided with a contact portion at a free end thereof, and each being configurable into an extended state in which its contact portion lies a first distance from the carrier plane, and into a retracted state in which its contact portion lies a second, smaller distance from the carrier plane;

the method comprising the steps of:
arranging the remover and the sheet relative to each other so that the plurality of actuators corresponds in position with the sheet,
engaging the contact portions of at least one of a group of the plurality of actuators of which the position corresponds to a target removable sheet part of the sheet with the target removable sheet part, the at least one actuator being in its extended state;
reconfiguring one or more of the engaged actuators of the group from its extended state to its retracted state with the target removable sheet part remaining engaged with the contact portion of said actuator to at least partially move the target removable sheet part from the sheet towards the carrier plane of the remover;
moving the remover away from the sheet with the contact portions of said one or more the actuators of the group being engaged with the target removable sheet part, and
performing an assisting operation with at least one actuator, preferably on the sheet with the contact portion thereof, prior to the step of moving the remover away from the sheet.

By performing assisting operation, efficiency of removal of the removable sheet parts may be increased. For instance, an expectation of a proper removal of the removable sheet parts may be improved and/or product cutouts (as removable sheet parts) with contour portions of complex geometry may be removed with increased expectation of success. Assisting operations may counteract the occurrence of dragging and/or trailing of sheet material from the remover. This way, errors in removal and/or damage to product cutouts may be prevented. Thereby, product cutout integrity can more easily be maintained.

The actuator may for example include a bellows with a flexible cup at its free end that forms the contact portion. The bellows may e.g. be biased towards extended state, e.g. using a spring load.

In the method, performing the assisting operation may include reconfiguration of at least one actuator of the plurality of actuators from its extended state to its retracted state with its contact portion unengaged. This way, a contact portion of the at least one actuator that overlaps in position with a contour of the target removable sheet part, which contour extends along a cut in the sheet, may be retracted to prevent engagement. Thereby, wrinkling of the removed sheet part may be counteracted. Preferably, the at least one actuator with contour overlap is configured in its retracted state before engagement of the contact portion of the actuators of the group. For instance, each actuator may be reconfigured from its extended state to its retracted state against a bias by sucking air from an interior of the bellows towards the remover faster than ambient air can be replenished in the interior of the bellows via a restricted air passage at the base of the cup. This way, the restriction allows a pressure difference to be built up with respect to the ambient, so that a retraction force is exerted on the bellows also when the cup is unengaged from a target removable sheet part.

Advantageously, a further actuator that is not part of the group may be brought into engagement with the sheet. This allows assisting operations to be performed on the sheet outside of the target removable sheet part, e.g. at an edge of the sheet part surrounding the contour of the removable sheet part adjacent to a cut in the sheet.

When said further actuator is brought into engagement with the sheet to exert contact pressure onto the sheet, the sheet may be held down locally, e.g. at an edge of the sheet part surrounding the contour of the removable sheet part adjacent to a cut in the sheet. Thereby, removal of the target removable sheet part may be facilitated. The contact pressure may be applied by moving the remover towards the sheet so as to compress the actuator while it is in extended state, e.g. compressing the cup and the bellows against the bias.

When said further actuator is adjacent to an actuator in the group, a contact portion of such further actuator may correspond in position to an edge of the sheet adjacent a cut extending at a contour of a removable sheet part.

By reconfiguring said further actuator from its extended state to its retracted state with its contact portion engaged, the sheet outside of the target removable sheet part may be lifted, preferably at edge of the sheet adjacent a cut extending at a contour of a removable sheet part. This may facilitate removal of the target sheet part, e.g. by reopening of a cut that may have (partly) closed due to creep or runout of tacky matrix material.

When said further actuator is subsequently reconfigured from its retracted state back to its extended state, the lifted sheet part may be dropped back in place, e.g. after reopening of the cut.

In the method, said further actuator may be reconfigured together with an adjacent actuator in the group that corresponds in position to an edge of the target removable sheet part. This allows lifting adjacent edges of the adjacent sheet part and removable sheet part to reopen cut extending between the sheet and the sheet part at location between said actuators, the adjacent actuator may be an adjacent extended actuator, an intermediate actuator corresponding in position to a cut that has been configured to its retracted state not being considered as an adjacent extended actuator.

In the method, performing the assisting operation may include subsequent reconfiguration of at least one further actuator of the plurality of actuators from the group from its extended state to its retracted state with its contact portion engaged. This allows for a wave like peeling motion to be exerted on the target removable sheet part which may further improve the removal efficiency.

When said further actuator from the group is subsequently reconfigured from its retracted state back to its extended state, the target removable sheet part may be dropped back so as to perform the wave like peeling motion as a prepeeling operation.

In the method, the step of moving the remover away from the sheet with the contact portions of said one or more the actuators of the group being engaged with the removable sheet part may include tilting of the carrying plane of the remover relative to the sheet. This way, the target sheet part to be removed in a peeling motion of relatively large scale.

When the target removable sheet parts are lifted from a sheet that is arranged in a horizontal, flat plane, the sheet parts may in particular comprise product cutouts nested in the sheet.

The methods described above may be used for sheets that comprise reinforcement fibers held in a matrix material, in particular a tacky matrix material.

It should be noted that the technical features and steps described above may each on its own be embodied in a method for removing sheet parts, such as product cutouts and removable sheet parts, from a sheet or a remover therefor, i.e. isolated from the context in which it is described here, separate from other features or in combination with only a number of features described in the context in which it is disclosed herein. Each of these features may further be combined with any other feature disclosed, in any combination.

The invention will be further elucidated on the basis of exemplary embodiments which are represented in the drawings. The exemplary embodiments are given by way of non-limitative illustration of the invention. In the drawings:

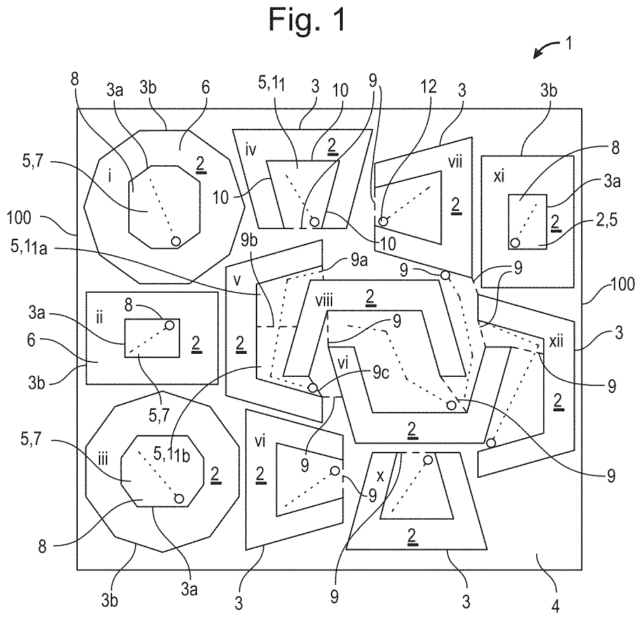

FIG. 1 shows a schematic top view of a sheet provided with product cutouts in accordance with an aspect of the invention;

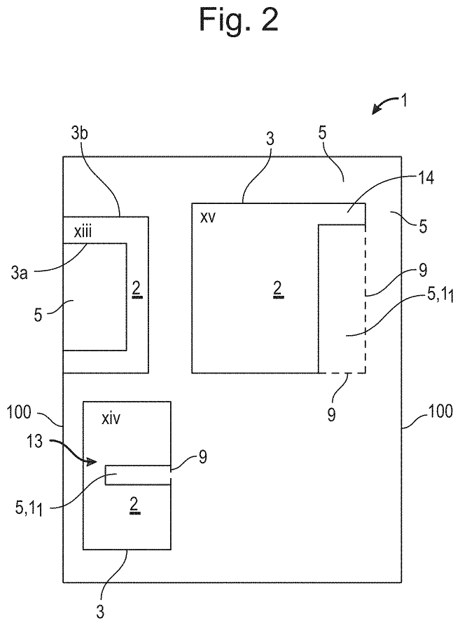

FIG. 2 shows a schematic top view of another sheet provided with product cutouts in accordance with an aspect of the invention;

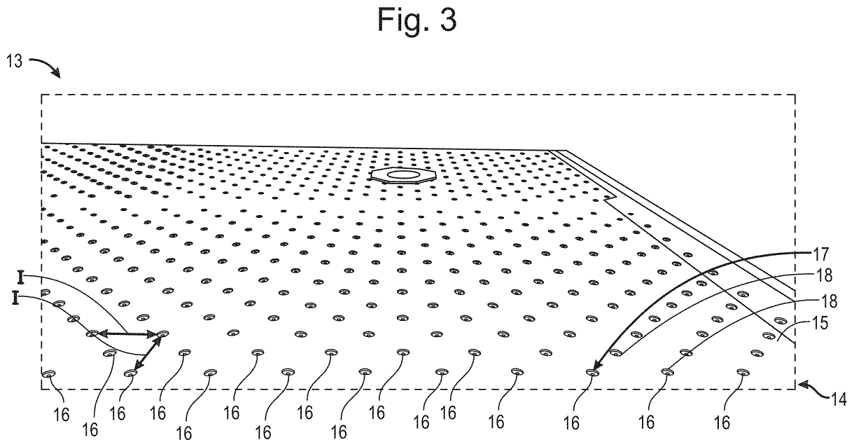

FIG. 3 shows a schematic perspective view of a pick-up plane in accordance with an aspect of the invention;

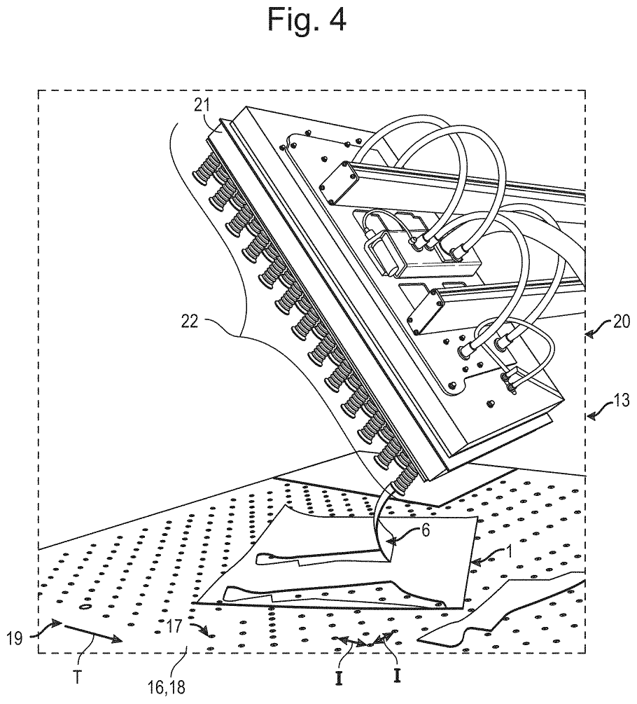

FIG. 4 shows a schematic perspective view of the pick-up plane of FIG. 3 together with a sheet provided with product cutouts and a product remover in accordance with an aspect of the invention;

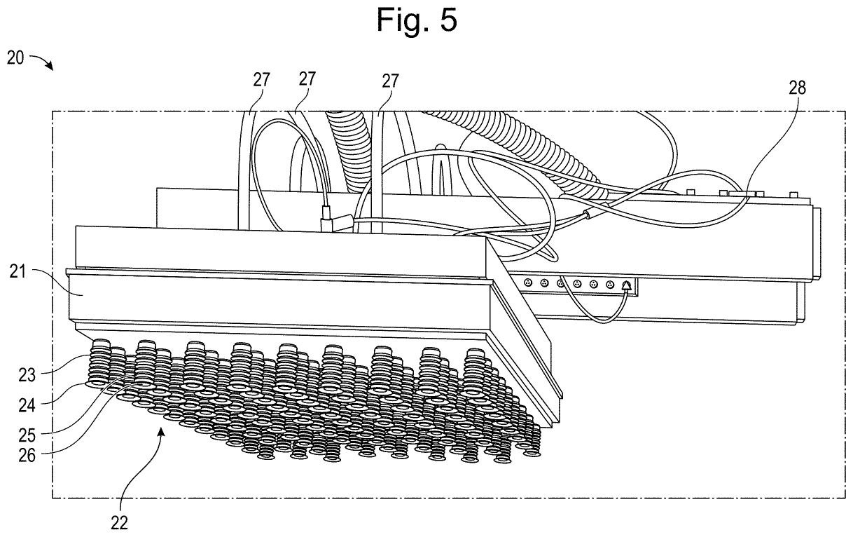

FIG. 5 shows a schematic perspective view of a product remover in accordance with an aspect of the invention;

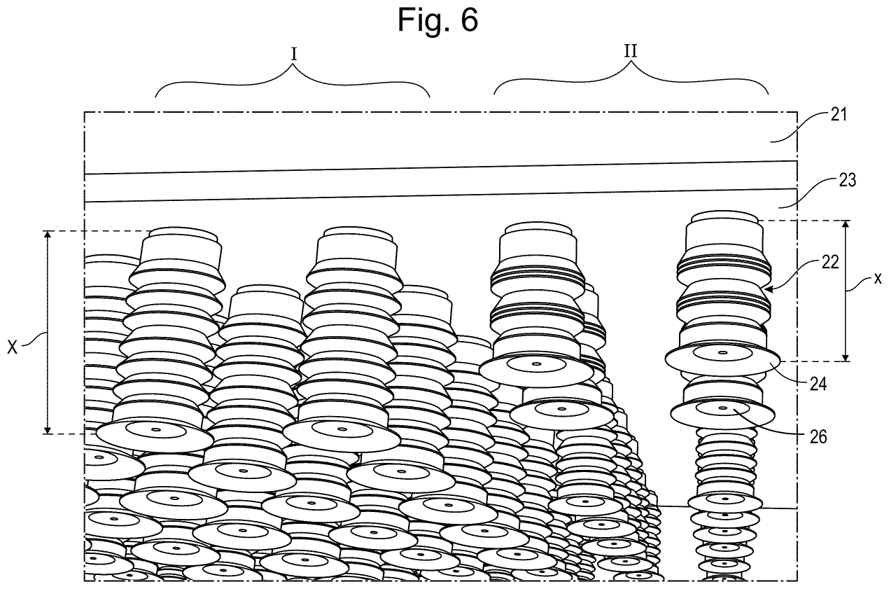

FIG. 6 shows a schematic perspective view of a detail of the product remover of FIG. 5.

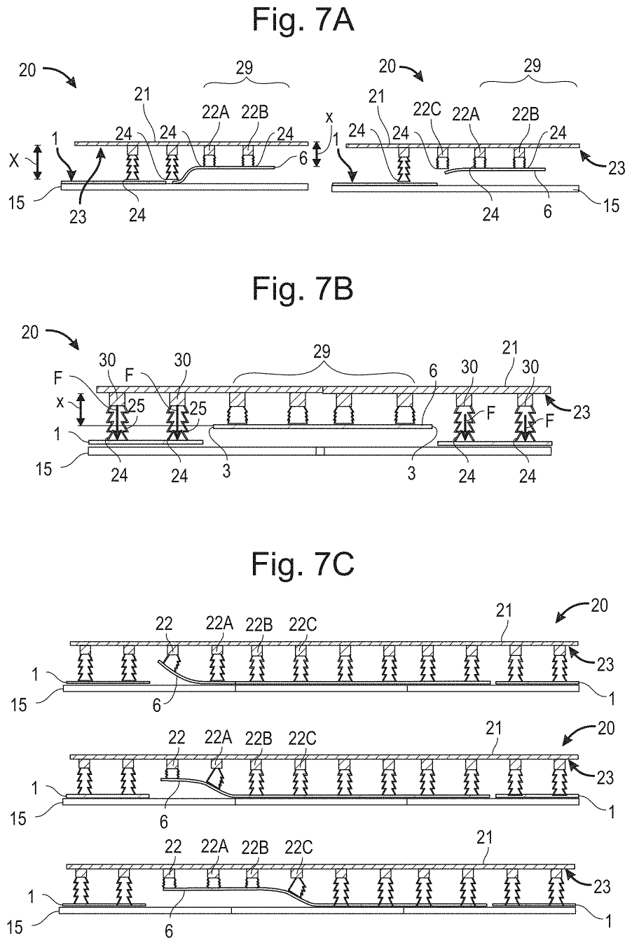

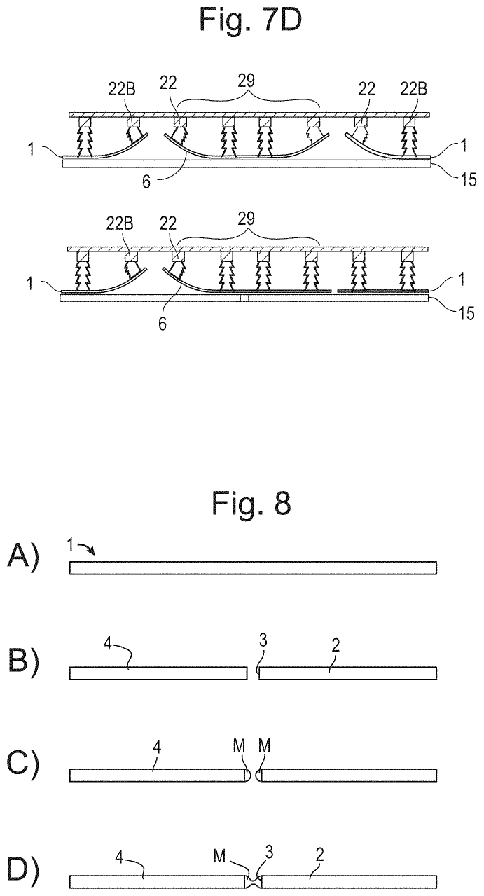

FIG. 7A-D show schematic side views of picking operations in accordance with aspects of the invention;

FIG. 8 shows a schematic side view representation of matrix runout along the contour of a product cutout;

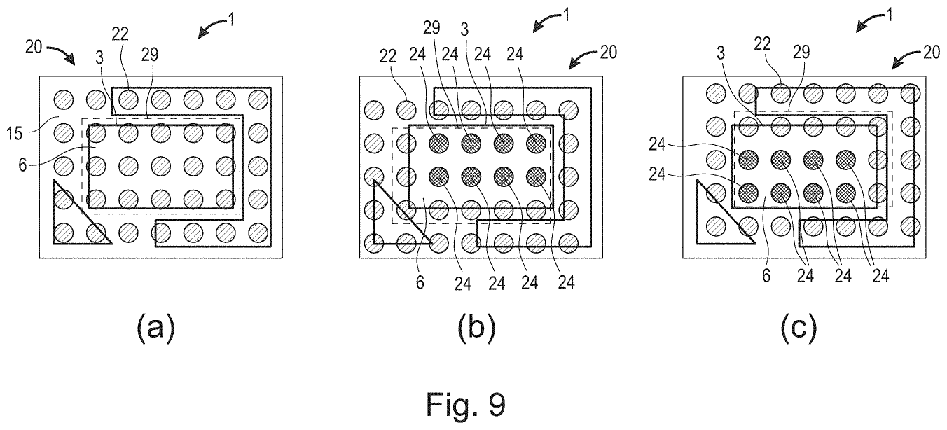

FIG. 9 shows a schematic sectional top view of a picking operation in accordance with a further aspect of the invention;

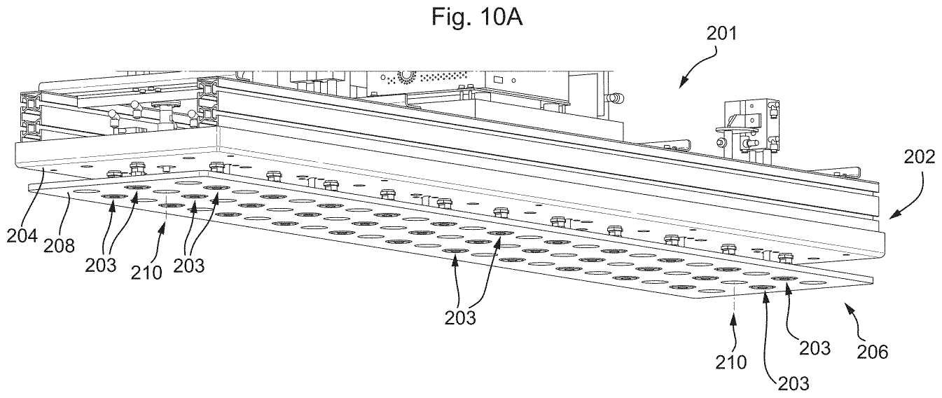

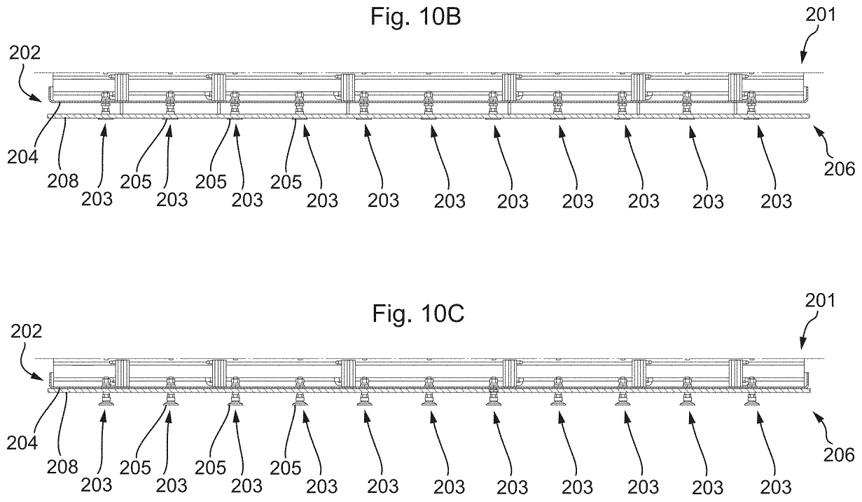

FIG. 10A shows a perspective view of a product remover, wherein a push plate is in an extended position;

FIG. 10B shows a cross sectional side view of the product remove of FIG. 10A;

FIG. 10C shows a cross sectional side view corresponding to FIG. 10B, wherein the push plate is in a retracted position;

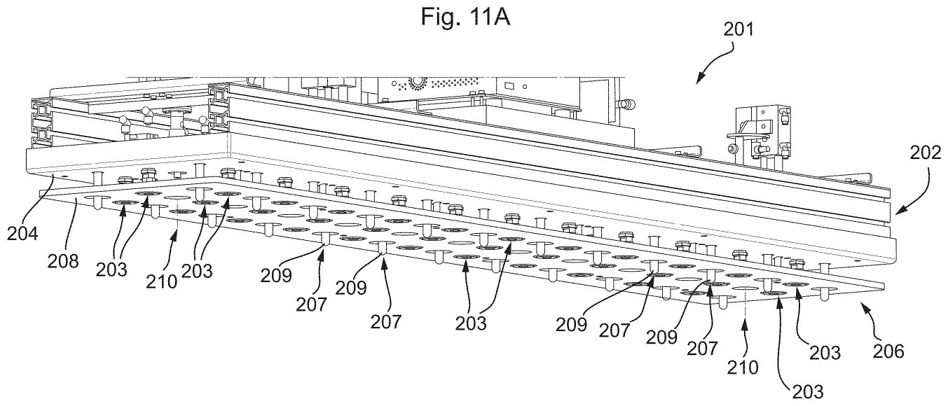

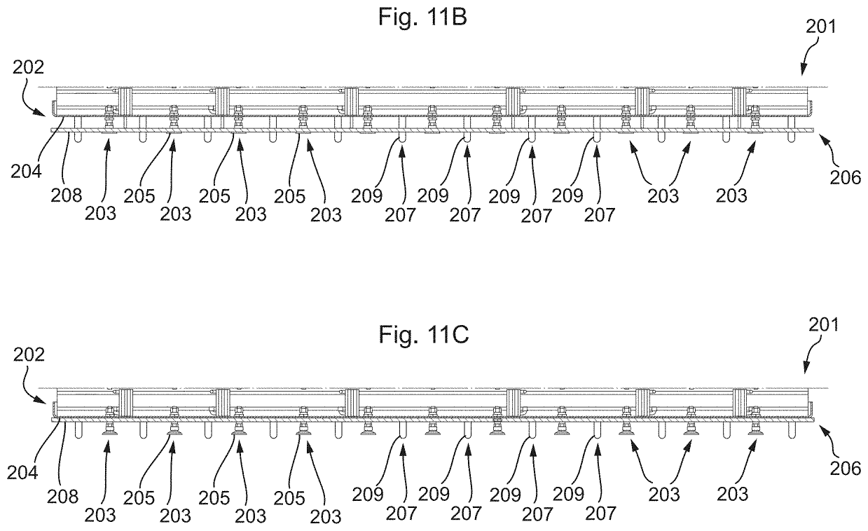

FIGS. 11A-C show views corresponding to FIGS. 10A-C, respectively, of a further product remover, wherein the product remover comprises push pins; and

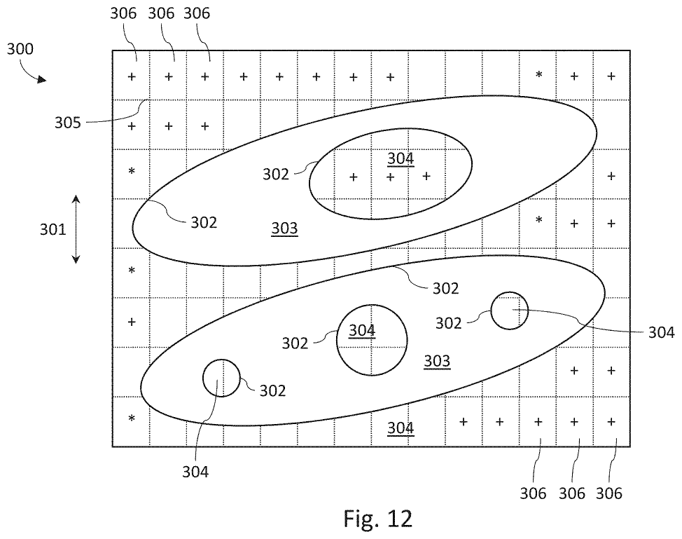

FIG. 12 shows an exemplary sheet cutting pattern for obtaining primary and secondary products from a sheet.

It is noted that the figures are merely schematic representations that are given by way of non-limited example. In the figures, identical or corresponding parts are represented with the same reference numerals.

FIG. 1 shows a sheet 1 provided with product cutouts 2. In the exemplary embodiment the sheet 1 comprises a reinforcement in the form of fibers embedded in a matrix material. Here, the fiber material is carbon fiber, but e.g. glass or aramid fibers may also be used. The matrix material comprises thermosetting material, but thermoplastic or other polymer materials may also be used. The matrix material is tacky. The product cutouts 2 have been made in the sheet 1 by cutting their respective contours 3. However, an (uncut) boundary 100 of the sheet 1 can also form part of the contour 3 of the product cutout 2, see e.g. product cutout 2 indicated with reference xiii. in FIG. 2.

Referring to FIG. 1, the sheet 1 comprises twelve product cutouts 2 that are numbered i.-xii. The remaining part of the sheet forms a skeleton 4. The cut for each product cutout 2 may be continuous or may be formed by one or more aggregate cuts. For example, the contour 3 of product 2 indicated with i. comprises an inner contour 3a and an outer contour 3b that are each defined by a respective portion of the cut. In this case, the inner contour 3a as a first portion of the cut of product cutout 2 with reference i. was cut in a first cutting stage and built up out of eight aggregate cuts. The outer contour 3b as a further portion of the cut was formed in a further cutting stage. Portions of the cut of the contour of a product cutout 2 may be out at various stages.

The product cutouts 2 are unfinished and still tacky. Matrix material may runout into the respective cuts as illustrated in FIG. 8 in four stages: A) uncut sheet 1; B). freshly cut sheet 1 with a product cutout 2 and the skeleton 4; C) runout or creep of matrix material M along the contour 3 of the product cutout 2 and along an adjacent contour of the skeleton 4; and D) cut partly closed by a new bond of matrix material M that has run out into the cut. Such a partly closed cut may further complicate successful removal of the product cutouts 2. The sheet in FIG. 8 comprises reinforcement fibers held in a matrix material, in particular a tacky matrix material. Sheets comprising other tacky materials such as adhesives may behave similarly.

Referring to FIG. 1, a removal of a product cutout 2 thus has a relatively low chance of removing only the complete product cutout 2. For example, product cutout 2 with reference i. as target product cutout 6 is O-shaped and when it is removed, there is a relatively high probability of inadvertent removal of excess sheet material. Here an inner part of the O-shape may be dragged along with this target product cut out 6. Product cutout 2 with reference ii. is another example of a target product cutout 6 of different shape compared to product cutout with reference i. having a relatively high probability of inadvertent removal of excess sheet material. In accordance with an aspect of the invention, a sheet part 5 that is adjacent to the target product cutout 6 is removed first from the sheet 1 to improve removability of the target product cutout 6 from the sheet in a further removal step. For instance, target product cutout 6 with reference i. has adjacent sheet part 5. In this case, the adjacent sheet part 5 is an auxiliary cutout 7 that forms a removable part of the skeleton 4 of the sheet 1 that contains the product cutouts 2. In particular, the target product cutout 6 surrounds the adjacent sheet part 5. Similarly, product cutouts 2 with references ii. and iii. surround respective adjacent sheet parts 5 that are auxiliary cutouts 7, in particular when that product cutout 2 is targeted for removal. Product cutout 2 with reference xi. surrounds an adjacent sheet part 5 that is also a product cutout 2. Removal of the respective adjacent sheet part 5 frees the inner contour 3a as part of the full contour 3 of the corresponding target product cutouts 6 for references i., ii., iii., and iv., thereby improving their removability. The contours of these adjacent sheet parts 5 each have at least one convex segment 8 that is adjacent to the respective target product cutout 6. Here, the convex segment 8 is understood as the convex of a polygon, in particular having an interior angle smaller than 180 degrees. However, the convex segment may also have a curved outline such as the exterior of a circle.

Product cutout 2 with reference iv. is substantially U-shaped and partly surrounds its adjacent sheet part 5. The legs of the U-shape each present a contour portion having a complex geometry. In particular, they are each relatively narrow and an end of each leg defines a contour portion having a relatively large perimeter to surface area ratio relative to the rest of the substantially U-shaped product cutout 2. Such a product cutout 2, and in particular the contour portion with the complex geometry, has a chance of trailing during removal and damaging the product cutout 2. However, this adjacent sheet part 5 does not form a removable sheet part of the sheet 1 without an auxiliary cutting line 9. In this case, an auxiliary cutting line 9 is positioned such that it closes a common cutting line 10 between the adjacent sheet part 5 and the product cutout 2 with reference iv. to form a closed loop so as to define a removable auxiliary cutout 11. As another example, product cutout 2 with reference v. is substantially V-shaped and partly surrounds its adjacent sheet part 5. Again, an end of each leg of the V-shape presents a contour portion having a complex geometry. Within this context, a complex geometry may e.g. be understood to be present when a part of the product cutout has a relatively large perimeter to surface ratio relative to the rest of the product cutout. Here, a first auxiliary cutting line 9a connects the contour 3 of the product cutout 2 with reference v. with the contour 3 of a neighbouring product cutout 2 with reference viii. at a first position. A second auxiliary cutting line 9b connects the contour 3 of the product cutout 2 with reference v. with the contour 3 of the neighbouring product cutout 2 with reference viii. at a second position. With the help of the auxiliary cutting lines 9a, 9b the removable auxiliary cutout 11a is defined. Similarly, a third auxiliary cutting line 9c is positioned to help define the removable auxiliary cutout 11b. In this case, the second auxiliary cutting line 9b divides the adjacent sheet part 5 in two which improves the removability of each removable auxiliary cutout 11a,11b. The sheet 1 comprises a plurality of auxiliary cutting lines 9 and by removing the removable auxiliary cutouts first, the removability of the product cutouts 2 to which they are adjacent may be improved. The sheet 1 has a boundary 100.

The adjacent sheet parts 5 are each peeled from the sheet 1. For example, the adjacent sheet part 5 to product cutout 2 with reference vii. is removed gradually starting from a starting point 12 at the contour of the adjacent sheet part such that a removed contour of the adjacent sheet part 5 increases incrementally. The starting point 12 is defined by an angle of ca. 100 degrees included in the contour of the adjacent sheet part 5, other angles of less than 180 degrees may also define a starting point, such as less than 165 degrees, less than 150 degrees, less than 135 degrees or less than 90 degrees.

Referring to FIG. 2, the sheet 1 comprises three product cutouts 2 with references xiii., xiv., and xv. The sheet 1 may e.g. be a separate sheet from the sheet shown in FIG. 1, but may also be a further section from the same sheet that has been uncoiled from a roll. The contour 3 of product cutout 2 with reference xiii. is partially formed by an uncut boundary 100 of the sheet 1. This product cutout 2 surrounds adjacent sheet part 5 in the sheet 1 whilst part of the contour of the adjacent sheet part 5 is formed by the uncut boundary 100 of the sheet 1. The product cutout 2 with reference xiv. as target product cutout 6 includes a recessed portion 13 that partly surrounds the adjacent sheet part 5. Due to the recessed portion 13, the target product cutout 6 has a chance of being damaged during removal. As discussed above, the auxiliary cutting line 9 provides an auxiliary cutout 11 that may be removed first to improve the removability of the target product cutout 6. As another example, the product cutout 2 with reference xv. as target product cutout includes a protruding part 14. The adjacent sheet part 5 partially surrounds the protruding part 14 of the target product cutout 6. The protruding part 14 has a chance of trailing behind in the sheet during removal and damaging the product cutout 2. The two auxiliary cutting lines 9 provide an auxiliary cutout 11 out of part the surrounding adjacent sheet part 5.

Referring to FIGS. 1 and 2, the auxiliary cutting lines 9 are provided as part of a respective cutting stage of the product cutouts 2. However, the auxiliary cutting lines 9 may for instance be provided in one or more auxiliary cutting stages the sheets 1 or at a later cutting stage, e.g. at a different location. The sheets 1 with product cutouts 2 and auxiliary cutting lines 9 are each supported on a substantially planar pick up plane (not shown). The pick up plane may present a relatively frictitious surface that faces the sheet 1 during use. The surface is arranged to grip the sheet 1 and hold it in place laterally along the pick up plane to further improve removability of the product cutouts 2. This and further advantageous aspects of such a pick up plane are described below in more detail for an exemplary embodiment.

FIG. 3 shows a table 13 for supporting a sheet 1 during removal of product cutouts 2 from the sheet 1 (FIGS. 1 and 2). The table 13 comprises a support structure 14 with a mat 15 as carrier supported thereon. The mat 15 has a substantially planar pick up plane that is arranged to face a sheet 1 during use. The pickup plane of the mat 15 presents a frictitious surface that is arranged to grippingly engage the sheet 1 with product cutouts 2 so as to hold the sheet 1 in place on the mat 15 laterally along the pick-up plane. In the exemplary embodiment, the mat 15 is of flexible plastics material, e.g. rubbery plastics material. The frictitious surface may e.g. be provided by providing the mat with a texture that is rough compared to the texture of the sheet.

Here, the mat 15 is provided with through apertures 16 opening upwardly towards the sheet 1 through which suction is applied to the sheet 1 during use. The suction is applied for engaging the sheet 1 transversely to the pick-up plane. The through apertures 16 are interspaced with regular spacing I. A carrier body of the mat 15 surrounding the apertures is airtight such that suction may be concentrated through the apertures during use.

The support structure 14 comprises a planar support 17 for the mat 15 as carrier. The support structure 14 is provided with through holes 18 opening upwardly towards the mat 15 through which suction is applied. The through holes 18 are arranged to register with the apertures 16 in the mat 15. The through holes 18 are interspaced with a further regular spacing underneath the mat 15 in the support. A support body surrounding the though holes 18 is made of an airtight material.

The support 17 includes at least two separately operable suction chambers (not shown). Each suction chamber is arranged to connect to a distinct set of the through holes 18, so that the apertures 16 are divided into at least two subgroups over the pick-up plane that are each separately actuatable. More than two separately operative suction chambers, such as three, four or more may also be provided.

FIG. 4 shows an endless conveyor 19 as carrier to move in a conveying direction T. The conveyor 19 comprises the same or similar features as described above for the mat 15 as carrier. The dimension of the apertures 16 in the conveying direction T of the conveyor 19 is larger than a dimension of through holes 18 in the conveying direction T. Preferably, the dimension of the apertures 16 in the conveyor 19 in the conveying direction T is equal to or larger than a pitch of intersp acing of the through holes 18 in the support 17 in conveying direction. This allows to retain at least one through hole 18 to be in registry with an aperture 16 so that suction may be exerted continuously through the hole 18 onto the sheet regardless of the conveying position of the conveying mat relative to the carrier in the conveying direction. A sheet 1 with product cutouts 2 is supported on the planar pick up plane of the conveying surface of the conveyor 19. A remover 20 comprising a carrier 21 having a plurality of actuators 22 is shown having at least one actuator 22 of the plurality in engagement with a target product cutout 6. The remover 20 is in the process of removing the target product cutout 6 from the sheet 1.

FIGS. 5 and 6 show a remover 20 comprising a carrier 21 having a plurality of actuators 22. The actuators extend from a carrying plane 23 of the carrier 21. The actuators 22 are each provided with a flexible cup 24 as a contact portion at a free end thereof. Alternatively, the contact portion may e.g. be an electrostatic gripper. The actuators 24 are each configurable into an extended state I in which its cup 24 lies a first distance X from the carrier plane 23, and into a retracted state II in which its cup 24 lies in a second, smaller distance x from the carrier plane 23. Each actuator 22 is provided with a bellows 25 that is biased towards the extended state I. Each bellows 25 is fluidly coupled to a suction device 28 via an opening in the carrying plane 23 and a respective conduit 27. Each actuator 22 further includes a restrictor 26 that is arranged to restrict passage of ambient air into the bellows 25. In particular, the restrictor 26 is configured to create an air flow difference along the bellows 25 between the ambient air flowing in through the restrictor 26 and air from an interior of the bellows being sucked out by the suction device 28. This allows each actuator to be reconfigured from its extended state I to its retracted state II against a bias by sucking air from an interior of the bellows 25 with the suction device 28 faster than ambient air can be replenished in the interior of the bellows 25 via the restricted air passage at the base of the cup 24. This way, the restriction 26 allows a pressure difference to be built up with respect to the ambient, so that a retraction force is exerted on the bellows 25.

FIG. 7A-D show examples of assisting operations performed with at least one actuator 22 according to aspects of the invention. The examples illustrate removal of a target removable sheet part, in particular a product cutout 2, from a sheet 1 using a remover 20. The sheet 1 is supported on a substantially planar pick up plane of a carrier 15, such as a mat or conveyor. Advantageously, the pick up plane presents a frictitious surface to grip the sheet 1 and comprises apertures to allow suction to be applied to the sheet 1 as described above. The remover 20 comprises a carrier 21 having a plurality of actuators 22 extending from a carrying plane 23 of the carrier 21. Each actuator 22 is provided with a contact portion 24 at a free end thereof. Each actuator 22 is configurable into an extended state I in which its contact portion 24 lies a first distance X from the carrier plane 23, and into a retracted state II in which its contact portion 24 lies a second, smaller distance x from the carrier plane 23. In the following, a target product cutout 6 serves as an example of a removable sheet part. In the examples, the remover 20 and the sheet 1 are arranged relative to each other so that the plurality of actuators 22 corresponds in position with the sheet 1. Also, the contact portions 24 of at least one of a group 29 of the plurality of actuators 22 of which the position corresponds to a target product cutout 6 is engaged with the target product cutout 6, by moving the remover 20 with the actuator 22 in extended state I transversely to the sheet 1 so that cups 24 of actuators 22 contact the target product cutout 6 in sealing engagement.

Referring to FIG. 7A, the situation without performing an assisting operation is depicted on the left hand side and with performing an assisting operation is depicted on the right hand side. In each case, two of the engaged actuators 22A, 22B of the group are reconfigured from their extended state I to their retracted state II with the target product cutout 6 remaining engaged with the contact portion 24 by applying suction to actuators 22A, 22B so that air is sucked out of the interior of their bellows 25. The sealing engagement between the cup 24 and the target product cutout 6 impedes or prevents ambient air flow into the bellows 25 such that a pressure difference with respect to the ambient is built up that exerts a retraction force on the actuators 22A, 22B. The target product cutout 6 is moved from the sheet 1 towards the carrier plane 23 of the remover 20. An assisting operation with actuator 22C of the plurality of actuators 22 is depicted on the right hand side, wherein said actuator 22C is reconfigured from its extended state I to its retracted state II with its contact portion 24 unengaged by applying suction to actuator 22C and let restricted air flow in through the restriction 26. Here, actuator 22C is adjacent to the group 29 and the contact portion 24 of actuator 22C overlaps in position with a cut extending at a contour 3 of the target product cutout 6. As can be seen by comparison on the left hand side of FIG. 7A this assisting operation counteracts wrinkling of the target product cutout 6.

Referring to FIG. 7B, four engaged actuators 22 of the group 29 are reconfigured to their retracted state II from their extended state I whilst engaging the target product cutout 6. The target product cutout is moved from the sheet 1 towards the carrier plane 23. Four further actuators 30 that are not part of the group 29 are brought into engagement with the sheet 1. This exemplary assisting operation is performed at an edge of the sheet part surrounding the contour 3 of the target product cutout 6 adjacent to a cut in the sheet 1. In particular, said further actuators 30 are brought into engagement with the sheet 1 to exert contact pressure F onto the sheet 1 and hold the sheet down locally. Thereby, removal of the target product cutout 6 is facilitated. The contact pressure F is applied by moving the remover 20 towards the sheet 1 so as to compress said further actuator 30 while it is in extended state I, e.g. compressing the contact portions 24 and the bellows 25 against their bias.

Referring to FIG. 7C, the performed assisting operation is displayed in consecutive steps and includes subsequent reconfiguration of further actuators 22A, 22B, 22C of the plurality of actuators 22 from the group 29 from its extended state I to its retracted state II. Their respective contact portions 24 are engaged. This allows for a wave like peeling motion to be exerted on the target product cutout 6 which may further improve the removal efficiency. Conversely, the performed assisting operation may further include the further actuators 22A, 22B, 22C from the group 29 subsequently being reconfigured from their retracted state II back to its extended state I. This way, the target product cutout 6 may be dropped back so as to perform the wave like peeling motion as a prepeeling operation.

Referring to FIG. 7D, the further actuator 22B is adjacent to an actuator 22 in the group 29. The contact portion 24 of the further actuator 22B corresponds in position to an edge of the sheet 1 adjacent a cut extending at a contour 3 of the target product cutout 6. The further actuator 22B is reconfigured from its extended state I to its retracted state II with its contact portion 24 engaged. The sheet 1 outside of the target product cutout 6 is lifted at an edge of the sheet 1 adjacent a cut extending at a contour 3 of the target product cutout 6. This may further facilitate removal of the target sheet part, e.g. by reopening of a cut that has (partly) closed due to creep or runout of tacky matrix material as described above and shown in FIG. 8. Additionally, the further actuator may be subsequently reconfigured from its retracted state back to its extended state. This way, the lifted sheet part may be dropped back in place, e.g. after reopening of the cut. Then the remover 20 may be moved away from the sheet.

FIG. 9 shows three phases of a target product cutout 6 as target removable sheet part in a sheet 1. The sheet 1 lies on a substantially planar pick up plane of a mat 15 as carrier. The mat 15 presents a frictitious surface that is arranged to grip the sheet 1 laterally along the pick up plane and has apertures through which suction is applied to the sheet 1 as described above. These features may provide further assistance to an assisting operation, but are not necessary. For example, the sheet 1 may alternatively lie on a different support or carrier.

FIG. 9 depicts a sectional view showing the contact portions 24 of the plurality of actuators 22 of the remover 20. In this exemplary embodiment, an assisting operation with at least one actuator is illustrated in three phases (a), (b), (c). In phase (a), the remover 20 and the sheet 1 are arranged relative to each other so that the plurality of actuators 22 corresponds in position with the sheet 1. As can be seen in phase (a), the contact portions 24 of the group 29 of the plurality of actuators 22 corresponds to the target product cutout 6 with overlap of the outer contact portions 24 of the group 29 along the contour 3 of the target product cutout 6. This may be detrimental to an expectation of a proper removal. To improve the removability of the target product cutout 6, the group 29 of the plurality of actuators is moved relative to the sheet 1 in phase (b) such that eight contact portions 24 of the group of actuators 22 are in engagement with a portion of the target product cutout 6. While engaged, the respective actuators 22 of the eight contact portions 24 are reconfigured from their extended state I to their retracted state II. The portion of the target product cutout 6 is lifted to reopen a cut that has (partly) closed due to creep or runout of matrix material. The respective actuators 22 of the eight contact portions 24 are then reconfigured from their retracted state II to their retracted state II to drop the lifted portion of the target product cutout 6 back in place.

Similarly, in phase (c) the group 29 of the plurality of actuators 22 is moved relative to the sheet 1 such that eight contact portions 24 of the group 29 of actuators 22 are in engagement with another portion of the target product cutout 6. These eight contact portions 24 may be the same or different from the eight contact portions 24 in phase (b). By reconfiguring the respective actuators 22 of the eight contact portions 24, the same process as described for phase (b) can be repeated or with the eight contact portions 24 engaged with the portion of the target product cutout 6, the remover 20 may move away from the sheet to remove the target product cutout 6. The removability of the target product cutout 6 is improved by loosening part of the contour 3 in phase (b) first, before removing the target product cutout 6.

Thus is described a method of removing product cutouts from a sheet, wherein a sheet part that is adjacent to a target product cutout is removed first from the sheet to improve removability of the target product cutout from the sheet in a further removal step.

Also, is described a method of removing a target removable sheet part, in particular a product cutout, from a sheet using a remover, comprising the steps of: arranging the remover and the sheet relative to each other so that the plurality of actuators corresponds in position with the sheet, engaging the contact portions of at least one of a group of the plurality of actuators of which the position corresponds to a target removable sheet part of the sheet with the target removable sheet part, the at least one actuator being in its extended state, reconfiguring one or more of the engaged actuators of the group from its extended state to its retracted state with the target removable sheet part remaining engaged with the contact portion of said actuator to at least partially move the target removable sheet part from the sheet towards the carrier plane of the remover, moving the remover away from the sheet with the contact portions of said one or more the actuators of the group being engaged with the target removable sheet part, performing an assisting operation with at least one actuator, in particular on the sheet with a contact portion thereof, prior to the step of moving the remover away from the sheet.

Further aspects and embodiments, which may be implemented separately from or in combination with other aspects and embodiments of the present disclosure, are described as follows, with particular reference to FIGS. 10A-C and 11A-C.

A remover 201 is provided for removing a target removable sheet part, such as an auxiliary or a product cutout, from a sheet. The remover 201 comprises a carrier 202 having a plurality of actuators 203 extending from a carrier plane 204 of the carrier 202. The actuators 203 are each provided with a contact portion 205 at a free end thereof. The actuators 203 are each configurable or configured into an extended state (shown throughout FIGS. 10A-C and 11A-C), in which its contact portion 205 lies a first distance from the carrier plane 204. Optionally, the actuators 203 are configurable into a retracted state in which its contact portion lies a second, smaller distance from the carrier plane 204. The actuators 203 are actuatable, e.g. by suction, at least in the extended state.

Such actuators 203 can advantageously actuate the target removable sheet part by suction. In FIGS. 10A-C and 11A-C only some of the actuators 203 and respective contact portions 205 have been provided with a reference number, to avoid unnecessary cluttering of the drawings.

The remover 201 preferably comprises at least one pusher 206, 207 having a respective engagement end 208, 209. The pusher 206 may be stationary with respect to the carrier plane 204, but is preferably actively movable with respect to the carrier plane 204 between on the one hand a respective retracted position which is less than the first distance from the carrier plane 204 and on the other hand a respective extended position which is at or beyond the first distance from the carrier plane 204.

Such a pusher 206, 207 can advantageously stabilize, flatten and/or compress a sheet or sheet part or stack of sheets or sheet parts, for example before, during and/or after actuation by the actuator 203. In particular, inadvertent mutual shifting of sheets or sheet parts, or other unintended movement of a sheet or sheet part, can thus be inhibited.

The at least one pusher 206, 207 may comprise a push plate 206 extending parallel to the carrier plane 204 and may preferably be actively movable transverse to the carrier plane 204. Preferably, the engagement end 208 of the push plate 206 is aligned with the contact portion 205 of the actuator 203, when the actuator 203 is in its extended state and the push plate 206 is in its extended position (see FIG. 10B).

FIG. 10A shows an exemplary push plate 206 being provided with passages (holes) through which e.g. the actuators 203 can extend.

Alternatively or additionally, the at least one pusher 206, 207 may comprise at least one push pin 207 (see FIGS. 11A-C) extendable from the carrier plane 204 transverse to the carrier plane 204. Preferably the push pin 207 is extendable from the carrier plane 204 beyond the contact portion 205 of the actuator 203 when the actuator 203 is in the extended state. Optionally, the push pin 207 is extendable from the carrier plane 204 beyond the engagement end 208 of the push plate 206 when the push plate 206 is in its extended position (see e.g. FIG. 11B). Thus, the engagement end 209 of the push pin 207 may be positionable beyond the engagement end 208 of the push plate 206.

The thus extended push pins 207 are preferably retractable towards and/or beyond the carrier plane 204, at least beyond the contact portion 205 of the actuators 203. When the push pins 207 are retracted beyond the carrier plane 204, configurations of the remover 201 as shown in FIG. 10A-C may be obtained.

The engagement end 209 of the push pin 207 is preferably configured to reduce stickiness to the engaged sheet or sheet part. For example, the engagement end 209 is substantially rounded to avoid excessive localized pressure or stress upon engagement. Alternatively or additionally the engagement end 209 is provided with or from a suitable non-sticking material, e.g. selected depending on a material of the engaged sheet or sheet part.

In FIGS. 11A-C only some of the push pins 207 and respective engagement ends 209 have been provided with a reference number, to avoid unnecessary cluttering of the drawings.

Alternatively or additionally, the remover 201 may comprise a joiner head 210, for example comprising an ultrasonic welding head and/or a heating head, which is extendable and retractable with respect to the carrier plane 204 between less than and at least up to the first distance from the carrier plane 204. In FIGS. 10A and 11A approximate positions of two such joiner heads 210 have been indicated, wherein the joiner heads 210 are shown in a retracted position, thereby not extending beyond the contact portion 205 of the actuators 203. Here the push plate 206 is provided with suitable passages for the joiner heads 210.

Further aspects and embodiments, which may be implemented separately from or in combination with other aspects and embodiments of the present disclosure, are described as follows, with particular reference to FIG. 12.

A method is provided of obtaining primary and secondary product cutouts from a sheet 300 comprising fibres, the sheet 300 having a main fibre direction 301. The method comprises cutting the sheet 300 along at least one primary contour 302 of at least one primary product, the primary contour 302 having a predetermined orientation with respect to the main fibre direction 301, thereby obtaining at least one primary product cutout 303 as well as at least one skeleton sheet part 304. Here, a skeleton sheet part 304 can be defined as a sheet part not corresponding to a primary product cutout 303. The method further comprises cutting the at least one skeleton sheet part 304 along a regular grid 305 which has a fixed alignment to the main fibre direction 301 throughout the grid 305, thereby obtaining a plurality of secondary product cutouts 306 which are substantially uniform in terms of shape and respective fibre direction.

In FIG. 12 such a regular grid 305 is indicated by a plurality of horizontal and vertical dotted lines. Six such secondary product cut outs 306 have been indicated with a reference number 306 in FIG. 12, while other such secondary product cut outs 306 have been indicated with a +-sign. Depending on application specific requirements, in particular regarding uniformity and/or completeness of the secondary product cut outs, further cut outs may be identified as secondary product cut outs, for example those indicated with a *-sign in FIG. 12. Meanwhile, as shown, other cut outs and/or skeleton sheet parts may still remain, i.e. not being treated as primary or secondary product cut outs. Such other cut outs or sheet parts may be discarded and/or used in a different way compared to the primary and secondary product cut outs.

Optionally, the method further comprises mutually separating at least one of the primary product cutouts 303 on the one hand and at least one of the secondary product cutouts 306 on the other hand, for example by first engaging a primary product cutout 303 and a secondary product cutout 306 together after cutting the sheet, and subsequently releasing the primary product cutout 303 and the secondary product cutout 306 separately from each other, in particular at mutually different times, for example at a distance from each other. Alternatively or additionally, a primary product cutout 303 and a second product cutout 306 may be engaged separately, e.g. sequentially.

Such secondary product cutouts 306 may be used in various ways, for example as so-called patches or feed stock for producing a compound laminate product from substantially randomly oriented patches.

While FIG. 12 shows the regular grid 305 as rectangular, it will be appreciated that different shapes and sizes of regular grids are possible, for example selected depending on application requirements and/or depending on a shape and/or size of a skeleton sheet part 304.

Here follows a set of numbered embodiments of a device for supporting a sheet provided with product cutouts, in particular for use in a method including aspects as discussed above:

Embodiment A1: Table for supporting a sheet during removal of product cutouts from the sheet, the table comprising a support structure with a carrier supported thereon, the carrier having a substantially planar pick up plane that is arranged to face the sheet, the pickup plane of the carrier presenting a frictitious surface that is arranged to grippingly engage the sheet with product cutouts so as to hold the sheet it in place on the carrier laterally along the pick-up plane.
Embodiment A2: Table according to embodiment A1, wherein the carrier is arranged as conveyor arranged to move in a conveying direction, in particular an endless conveyor.
Embodiment A3: Table according to embodiment A1 or A2, wherein the carrier is provided with through apertures opening upwardly towards the sheet through which suction is applied to the sheet for engaging the sheet transversely to the pick-up plane.
Embodiment A4: Table according to any of the preceding embodiments A1-A3, wherein the support structure comprises a planar support for the carrier, and wherein the support structure is provided with through holes opening upwardly towards the carrier through which suction is applied, the through holes being arranged to register with the apertures in the carrier.
Embodiment A5. Table according to any of the preceding embodiments A1-A4, wherein the support includes at least two separately operable suction chambers, and wherein each suction chamber is arranged to connect to a distinct set of the through holes, so that the apertures are divided into at least two subgroups over the pick-up plane that are each separately actuatable.

Here follows a further set of numbered embodiments of a remover for removing a target removable sheet part, such as an auxiliary or a product cutout, from a sheet, in particular for use in a method including aspects discussed above:

Embodiment B1: A remover comprising a carrier having a plurality of actuators extending from a carrying plane of the carrier, the actuators each being provided with a contact portion at a free end thereof, and each being configurable, or configured, into an extended state in which its contact portion lies a first distance from the carrier plane, and optionally configurable into a retracted state in which its contact portion lies a second, smaller distance from the carrier plane, wherein the actuators are actuatable by suction, at least in the extended state.
Embodiment B2: A remover according to embodiment B1, wherein each actuator includes a bellows with a flexible cup as contact portion and a restrictor at a base of the flexible cup that is arranged to restrict air passage into the bellows relative to a suction applied to an interior of the bellows.
Embodiment B3: A remover according to embodiment B2, wherein each bellows is fluidly coupled to a suction device via an opening in the carrying plane and a respective conduit 27.
Embodiment B4: A remover according to embodiment B2 or B3, wherein the bellows is biased towards the extended state.
Embodiment B5: A remover according to any of the preceding embodiments B1-B4, further comprising at least one pusher having a respective engagement end which is preferably actively movable with respect to the carrier plane between on the one hand a respective retracted position which is less than the first distance from the carrier plane and on the other hand a respective extended position which is at or beyond the first distance from the carrier plane.
Embodiment B6: A remover according to embodiment B5, wherein the at least one pusher comprises a push plate extending parallel to the carrier plane and preferably being actively movable transverse to the carrier plane, wherein preferably the engagement end of the push plate is aligned with the contact portion of the actuator when the actuator is in its extended state and the push plate is in its extended position.
Embodiment B7: A remover according to any of the preceding embodiments B5-B6, wherein the at least one pusher comprises at least one push pin extendable from the carrier plane transverse to the carrier plane, wherein preferably the push pin is extendable from the carrier plane beyond the contact portion of the actuator when the actuator is in the extended state, wherein optionally the push pin is extendable from the carrier plane beyond the engagement end of the push plate when the push plate is in its extended position.
Embodiment B8: A remover according to any of the preceding embodiments B1-B7, further comprising a joiner head, for example comprising an ultrasonic welding head and/or a heating head, which is extendable and retractable with respect to the carrier plane between less than and at least up to the first distance from the carrier plane.

Here follows a further set of numbered embodiments of a method of obtaining primary and secondary product cutouts from a sheet, in particular for combination with a method including aspects discussed above and/or using a remover including aspects discussed above:

Embodiment C1: A method of obtaining primary and secondary product cutouts from a sheet comprising fibres, the sheet having a main fibre direction, the method comprising: cutting the sheet along at least one primary contour of at least one primary product, the primary contour having a predetermined orientation with respect to the main fibre direction, thereby obtaining at least one primary product cutout as well as at least one skeleton sheet part, wherein a skeleton sheet part is defined as a sheet part not corresponding to a primary product cutout; and cutting the at least one skeleton sheet part along a regular grid which has a fixed alignment to the main fibre direction throughout the grid, thereby obtaining a plurality of secondary product cutouts which are substantially uniform in terms of shape and respective fibre direction.
Embodiment C2: A method according to embodiment C1, further comprising mutually separating at least one of the primary product cutouts on the one hand and at least one of the secondary product cutouts on the other hand, for example by first engaging a primary product cutout and a secondary product cutout together after cutting the sheet, and subsequently releasing the primary product cutout and the secondary product cutout separately from each other, in particular at mutually different times, for example at a distance from each other.

Many variations will be apparent to the person skilled in the art. Such variations are understood to be comprised within the scope of the invention defined in the appended claims.

1. A method of removing a target removable sheet part from a sheet using a remover, the remover comprising a carrier having a plurality of actuators extending from a carrying plane of the carrier, the actuators each being provided with a contact portion at a free end thereof, and each being configurable into an extended state in which its contact portion lies a first distance from the carrier plane, and into a retracted state in which its contact portion lies a second, smaller distance from the carrier plane;
the method comprising the steps of:
arranging the remover and the sheet relative to each other so that the plurality of actuators corresponds in position with the sheet,
engaging the contact portions of at least one of a group of the plurality of actuators of which the position corresponds to a target removable sheet part of the sheet with the target removable sheet part, the at least one actuator being in its extended state;
reconfiguring one or more of the engaged actuators of the group from its extended state to its retracted state with the target removable sheet part remaining engaged with the contact portion of said actuator to at least partially move the target removable sheet part from the sheet towards the carrier plane of the remover;
moving the remover away from the sheet with the contact portions of said one or more the actuators of the group being engaged with the target removable sheet part, and
performing an assisting operation with at least one actuator prior to the step of moving the remover away from the sheet.

2. The method according to claim 1, wherein performing the assisting operation includes reconfiguration of at least one actuator of the plurality of actuators from its extended state to its retracted state with its contact portion unengaged.

3. The method according to claim 1, wherein a further actuator that is not part of the group is brought into engagement with the sheet.

4. The method according to claim 3, wherein said further actuator is brought into engagement with the sheet to exert contact pressure onto the sheet.

5. The method according to claim 3, wherein said further actuator is adjacent to an actuator in the group.

6. The method according to claim 3 wherein said further actuator is reconfigured from its extended state to its retracted state with its contact portion engaged.

7. The method according to claim 6, wherein said further actuator is subsequently reconfigured from its retracted state back to its extended state.

8. The method according to claim 6, wherein said further actuator is reconfigured together with an adjacent actuator in the group that corresponds in position to an edge of the target removable sheet part.

9. The method according to claim 1, wherein performing the assisting operation includes subsequent reconfiguration of at least one further actuator of the plurality of actuators from the group from its extended state to its retracted state with its contact portion engaged.

10. The method according to claim 9, wherein said further actuator from the group is subsequently reconfigured from its retracted state back to its extended state.

11. The method according to claim 1, wherein the step of moving the remover away from the sheet with the contact portions of said one or more the actuators of the group being engaged with the removable sheet part includes tilting of the carrying plane of the remover relative to the sheet.

12. The method according to claim 1, wherein target removable sheet parts are lifted from a sheet that is arranged in a horizontal, flat plane.

13. The method according to claim 1, wherein the sheets comprise reinforcement fibers held in a matrix material.

14. The method of removing product cutouts from a sheet using a method according to claim 42, wherein a sheet part that is adjacent to a target product cutout is removed first from the sheet to improve removability of the target product cutout from the sheet in a further removal step.

15-22. (canceled)

23. The method according to claim 14, wherein the removal step is performed by a remover comprising a carrier having a plurality of actuators arranged to engage target product cutouts and/or adjacent sheet parts, wherein the remover moves away from the sheet with a group of the actuators being engaged with the adjacent sheet part first such that the target product cutout can be removed in a further removal step.

24. The method according to claim 14, wherein the sheet is supported on a substantially planar pick-up plane, wherein the pick-up plane facing the sheet presents a relatively frictitious surface that is arranged to grip the sheet with product cutouts and hold it in place laterally along the pick-up plane.

25. The method according to claim 24, wherein the pick-up plane moves during removal in a transport direction.

26. The method according to claim 24, wherein the pick-up plane comprises apertures opening upwardly towards the sheet through which suction is applied to the sheet for engaging the sheet transversely to the pick-up plane.

27. The method according to claim 14, wherein removal of the adjacent sheet part is done gradually starting from a starting point at the contour of the adjacent sheet part, wherein a removed contour of the adjacent sheet part increases incrementally.

28. The method according to claim 27, wherein the starting point is defined by an angle in the contour of the adjacent sheet part, forming an angle of less than 180 degrees.

29-36. (canceled)

37. A remover comprising a carrier having a plurality of actuators extending from a carrying plane of the carrier, the actuators each being provided with a contact portion at a free end thereof, and each being configurable, or configured, into an extended state in which its contact portion lies a first distance from the carrier plane, and configurable into a retracted state in which its contact portion lies a second, smaller distance from the carrier plane, wherein the actuators are actuatable by suction, at least in the extended state,
wherein each actuator includes a bellows with a flexible cup as contact portion and a restrictor at a base of the flexible cup that is arranged to restrict air passage into the bellows relative to a suction applied to an interior of the bellows.

38. The remover according to claim 37, wherein each bellows is fluidly coupled to a suction device via an opening in the carrying plane and a respective conduit.

39. The remover according to claim 37, wherein the bellows is biased towards the extended state.

40. The remover according to claim 37, further comprising at least one pusher having a respective engagement end which is actively movable with respect to the carrier plane between on the one hand a respective retracted position which is less than the first distance from the carrier plane and on the other hand a respective extended position which is at or beyond the first distance from the carrier plane.

41. The method according to claim 13, wherein the matrix material is a tacky matrix material.

42. The method according to claim 1, wherein the target removable sheet part is a target product cutout.
